(19) United States
(12) Patent Application Publication
(10) Pub. No.: US 2024/0363268 A1
(43) Pub. Date: Oct. 31, 2024

(54) CONDUCTIVE MEMBER AND THERMISTOR ELEMENT USING THE SAME

(71) Applicant: TDK Corporation, Tokyo (JP)

(72) Inventors: Kazuya MAEKAWA, Tokyo (JP); Shinji HARA, Tokyo (JP); Naoki OHTA, Tokyo (JP); Susumu AOKI, Tokyo (JP); Maiko KOKUBO, Tokyo (JP); Takahiro NAKAGAWA, Tokyo (JP)

(21) Appl. No.: 18/641,882

(22) Filed: Apr. 22, 2024

(30) Foreign Application Priority Data
Apr. 27, 2023 (JP) 2023-073462

(51) Int. Cl. H01C 7/00; H01C 1/14

(52) U.S. Cl. CPC H01C 7/008; H01C 1/14

(57) ABSTRACT

Conductive member 31 comprises a plurality of conductive nitride layers 32 and at least one nitride-metal layer 33 that includes a conductive nitride and a metal. The conductive nitride layers 32 and the at least one nitride-metal layer 33 are alternately stacked. Nitride-metal layer 33 includes metal dispersion layer 33A in which the metal is dispersed in the conductive nitride.

### FIELD

The present application is based on, and claims priority from, JP2023-073462, filed on Apr. 27, 2023, the disclosure of which is hereby incorporated by reference herein in its entirety.

The present disclosure relates to a conductive member and a thermistor element using the same.

### BACKGROUND

A thermistor element used in an infrared sensor or the like includes a thermistor film in which electrical resistance changes depending on temperature. JP 2022-89431 A discloses an example of a thermistor film. An electrode is connected to the thermistor film, and the electrode is connected to a conductive pattern on an arm portion that supports the thermistor film.

### SUMMARY

As described in JP 2022-89431 A, an electrode layer and a wiring layer are generally electrically connected to the thermistor film. Since the electrode layer and wiring layer are conductors, they have high thermal conductivity. On the other hand, in order to improve the detection accuracy by the thermistor film, it is desirable to reduce thermal radiation from the thermistor film. For this purpose, it is desirable to reduce the thermal conductivity of the electrode layer and wiring layer connected to the thermistor film. Such problems may exist not only in the electrode layer and wiring layer of the thermistor element, but also in other conductive members.

It is desirable to provide a conductive member that can suppress thermal conductivity while suppressing a decrease in electrical resistance.

According to the present disclosure, a conductive member comprises a plurality of conductive nitride layers and at least one nitride-metal layer that includes a conductive nitride and a metal, the conductive nitride layers and the at least one nitride-metal layer being alternately stacked. The nitride-metal layer includes a metal dispersion layer in which the metal is dispersed in the conductive nitride.

### BRIEF DESCRIPTION OF THE DRAWINGS

FIG. 1 is a schematic exploded perspective view of an infrared sensor according to a first embodiment of the present disclosure;

FIG. 2 is a schematic perspective view of a thermistor element;

FIG. 3 is a schematic cross-sectional view of the thermistor element taken along line A-A in FIG. 2;

FIGS. 4A to 4C are schematic cross-sectional views of the conductive member shown in FIG. 3;

FIGS. 5A to 5C are schematic cross-sectional views showing a method of forming the conductive member shown in FIGS. 4A to 4C;

FIG. 6 is a schematic cross-sectional view of a conductive member according to a second embodiment of the present disclosure;

FIGS. 7A to 7C are schematic cross-sectional views of a conductive member according to a third embodiment of the present disclosure; and

FIG. 8 is a schematic diagram of a film-forming apparatus used in working examples.

### DETAILED DESCRIPTION

### First Embodiment

Embodiments of a conductive member of the present disclosure and a thermistor element using the same will be described with reference to the drawings. A thermistor element is used, for example, in an infrared sensor, which is an example of an electromagnetic wave sensor. Infrared sensors mainly detect long-wavelength infrared rays having wavelengths of approximately 8 to 14 μm. The electromagnetic waves to be detected are not limited to infrared rays, and may be terahertz waves with a wavelength of, for example, 100 μm to 1 mm.

### Configuration of Infrared Sensor 1

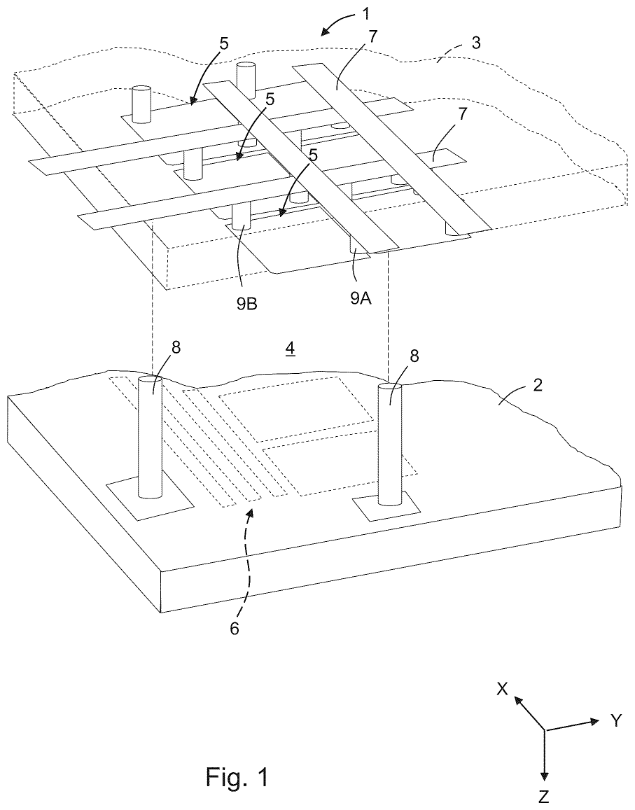

FIG. 1 shows a schematic partial perspective view of infrared sensor 1. In FIG. 1, illustration of first and second wiring layers 10A and 10B, which will be described later, is omitted. Infrared sensor 1 includes first substrate 2 and second substrate 3 that are arranged to face each other, and side walls (not shown) that connect first substrate 2 and second substrate 3. Sealed inner space 4 is formed by first substrate 2, second substrate 3, and the side walls. A plurality of thermistor elements 5 are provided in inner space 4. The thermistor elements 5 are supported by second substrate 3 and forms a two-dimensional grid array. Inner space 4 is under negative pressure or is a vacuum. Therefore, gas convection in inner space 4 is prevented or suppressed, and thermal influence on thermistor element 5 can be reduced. Element 6 such as a ROIC (Readout IC) is formed on first substrate 2. A plurality of leads 7 electrically connected to the thermistor elements 5 is formed on second substrate 3. Infrared entry portion 31 (see FIG. 3) is formed at a part of second substrate 3 that faces thermistor element 5. First substrate 2 and second substrate 3 are connected by a plurality of electrical connection members 8.

### Configuration of Thermistor Element 5

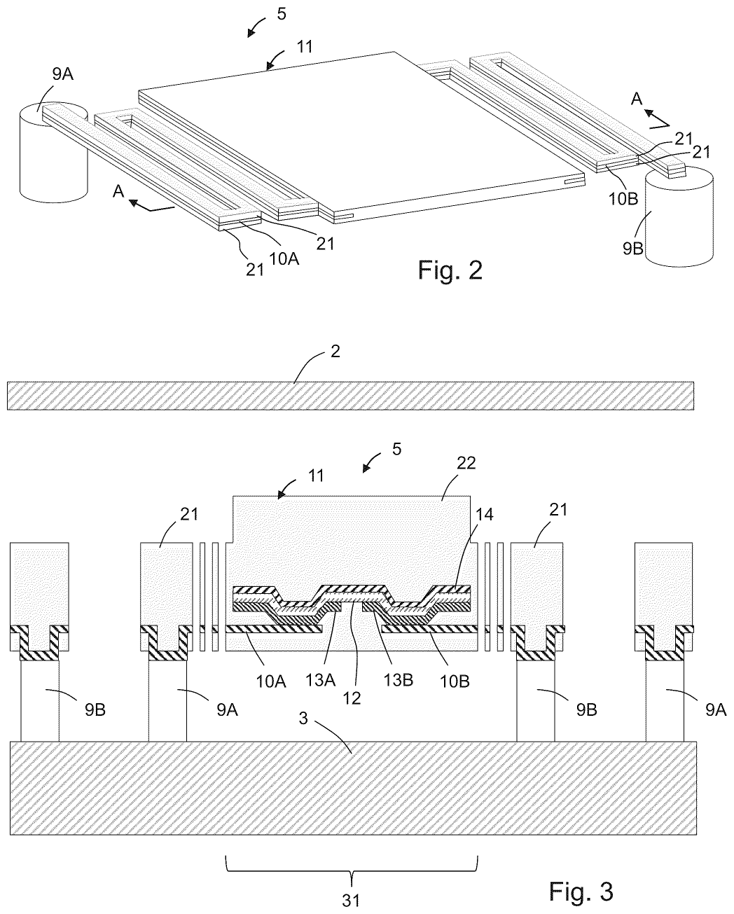

FIG. 2 is a perspective view of thermistor element 5, and FIG. 3 is a cross-sectional view of thermistor element 5 taken along line A-A in FIG. 2. FIG. 3 also shows first and second conductive pillars 9A and 9B, and first and second wiring layers 10A and 10B disposed thereon. For convenience, FIGS. 2 and 3 are shown upside down with respect to FIG. 1. Further, in FIG. 3, the dimensions of thermistor element 5 in the thickness direction are enlarged from the respective dimensions in FIG. 2. Thermistor element 5 includes main body 11 including thermistor film 12, first and second wiring layers 10A and 10B connected to main body 11, and first and second conductive columns 9A and 9B. First wiring layer 10A extends from first conductive column 9A to first lower electrode layer 13A, which will be described later. Second wiring layer 10B extends from second conductive column 9B to second lower electrode layer 13B, which will be described later. First and second wiring layers 10A and 10B are made from a conductor, both surfaces of which are covered outside of main body 11 by dielectric layer 21 except for the points of connection with first and second conductive columns 9A and 9B. As shown in FIG. 1, first conductive column 9A and second conductive column 9B are each connected to corresponding leads 7. The parts of first and second wiring layers 10A and 10B outside main body 11 have a meandering shape in order to reduce the influence of heat from, for example, elements 6, but the shape of first and second wiring layers 10A and 10B is not limited.

Referring to FIG. 3, main body 11 comprises thermistor film 12, first and second lower electrode layers 13A and 13B that are in contact with the surface of thermistor film 12 that faces second substrate 3, and upper electrode layer 14 that is in contact with the surface of thermistor film 12 that faces first substrate 2. First and second lower electrode layers 13A and 13B and upper electrode layer 14 are made from a conductor. First wiring layer 10A is in contact with first lower electrode layer 13A, and second wiring layer 10B is in contact with second lower electrode layer 13B. At least a part of each main body 11 for thermistor film 12, first and second lower electrode layers 13A and 13B, and first and second wiring layers 10A and 10B is covered with dielectric layer 22. Dielectric layer 22 is composed of aluminum nitride, silicon nitride, aluminum oxide, silicon oxide, or the like, and functions as an electromagnetic wave absorber. A gap is provided between first lower electrode layer 13A and second lower electrode layer 13B.

Thermistor film 12 is, for example, a film of vanadium oxide, titanium oxide, amorphous silicon, polycrystalline silicon, an oxide with a spinel crystal structure including manganese, or a film of yttrium-barium-copper oxide.

### Operating Principle of Infrared Sensor 1

Infrared sensor 1 configured as described above operates, for example, in the following manner. Infrared rays that are incident to infrared entry portion 31 of second substrate 3 enter the array of thermistor elements 5. When the incident infrared rays are absorbed by dielectric layer 22 and thermistor film 12, the temperature of thermistor film 12 changes, which in turn changes the resistance of thermistor film 12. A sense current sequentially flows through one electrical connection member 8, first conductive support 9A, first wiring layer 10A, main body 11, second wiring layer 10B, second conductive support 9B, and the other electrical connection member 8. Inside main body 11, the sense current sequentially flows through first wiring layer 10A, first lower electrode layer 13A, thermistor film 12, upper electrode layer 14, thermistor film 12, second lower electrode layer 13B, and second wiring layer 10B. That is, the sense current flows through thermistor film 12 in the direction of film thickness. Omitting upper electrode layer 14 can cause the sense current to also flow in the in-plane direction of thermistor film 12. The change in resistance of thermistor film 12 is detected as a voltage change by the ROIC of first substrate 2, and the ROIC converts this voltage signal into a brightness temperature. All thermistor elements 5 are scanned to obtain image data sufficient for displaying one screen.

### Configuration of Conductive Member 31

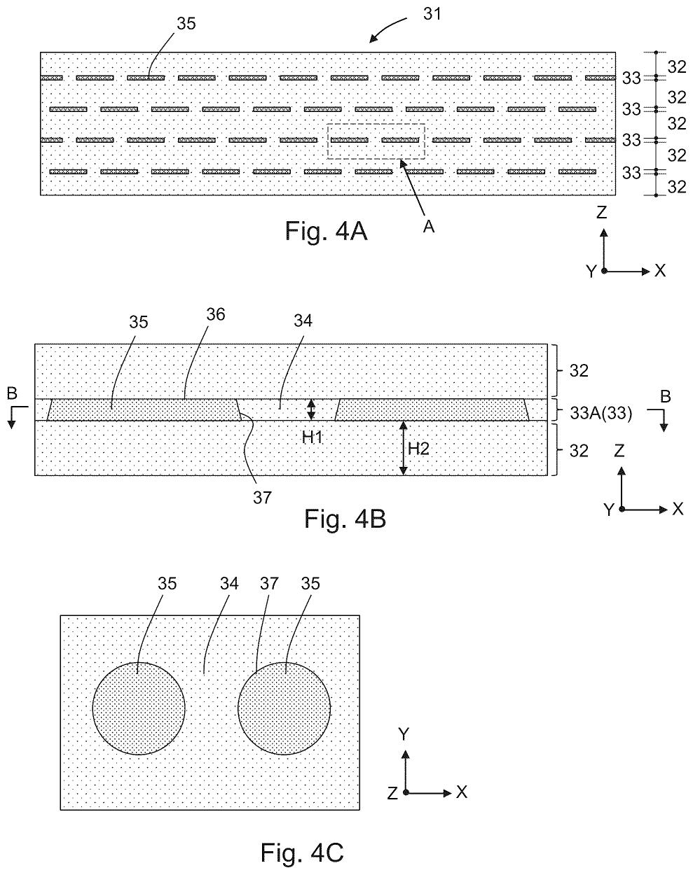

FIG. 4A to 4C are conceptual diagrams of conductive member 31, FIG. 4A showing a sectional view, FIG. 4B showing an enlarged view of part A in FIG. 4A, and FIG. 4C showing a sectional view taken along line B-B in FIG. 4B. At least one of first and second wiring layers 10A and 10B, first and second lower electrode layers 13A and 13B, and upper electrode layer 14 (hereinafter, these may be collectively referred to as conductive layers) is made from conductive member 31 which will be described later. For example, first and second wiring layers 10A and 10B, first and second lower electrode layers 13A and 13B, and upper electrode layer 14 may all be made from conductive member 31, or some of them (For example, only first and second wiring layers 10A and 10B, or only first and second lower electrode layers 13A and 13B) may be made from conductive member 31.

The purpose of conductive member 31 will next be explained. If the radiant thermal energy that has entered thermistor film 12 dissipates heat through the conductive layer, the detection accuracy of infrared sensor 1 will be reduced. Therefore, it is desirable to suppress thermal dissipation from the conductive layer. Thermal dissipation from the conductive layer is caused by thermal conduction of the conductive layer. Thermal conduction in solids is carried out by the vibrations of atoms. In particular, thermal conduction in conductive materials such as metals is thought to involve two mechanisms: energy transfer based on vibrations (phonons/lattice vibrations) transmitted between crystal lattices; and energy transfer based on the movement of conduction electrons. Since conduction electrons make a large contribution to energy transfer in conductive materials, conductive materials are generally good conductors of electricity and heat (Wiedemann-Franz law). Therefore, although the conductive layer has a smaller volume than dielectric layers 21 and 22, the conductive layer cannot be ignored as a heat transfer path. However, since thermal conduction via phonons also constitutes a portion of thermal conduction in the conductive layer, thermal dissipation from the conductive layer can be suppressed by reducing thermal conduction due to phonons.

In gas molecular kinetic theory, mean free path is the average distance that particles such as molecules and electrons can travel without being disturbed by scattering (collision) (called free path) by scattering sources (which may be the same particle or different particles). Particles perform ballistic linear motion, change direction when they collide with a scattering source, and then perform ballistic linear motion again. A particle that moves a distance equal to its mean free path will on average collide with another particle once. This concept can also be applied to phonons. The distance a phonon travels until it collides with another substance has a stochastic distribution, and the average travel distance (mean free path) of a phonon is an index of the ease with which phonons conduct heat. That is, reducing thermal conduction by phonons is equivalent to reducing the mean free path of phonons.

The mean free path of electrons in the conductive layer is smaller than the mean free path of electrons in an infinite medium. However, since the mean free path of electrons in an infinite medium is about several hundred nm, the mean free path of electrons in a conductive layer will not decrease significantly compared to the mean free path in an infinite medium, regardless of the structure of the conductive layer. The mean free path of phonons in a conductive layer is also smaller than the mean free path of phonons in an infinite medium. Since the mean free path of a phonon in an infinite medium is several μm, which is longer than the mean free path of an electron in an infinite medium, the mean free path of phonons is more easily influenced by the structure of the conductive layer than is the mean free path of electrons. Therefore, by adopting a structure that shortens the mean free path of phonons, it is possible to realize a conductive layer with reduced thermal conductivity while preventing a reduction in conductivity (increase in specific resistance). Conductive member 31 used in the conductive layers is constructed based on this basic principle, and as a result, the mean free path of phonons can be shortened without significantly affecting the mean free path of electrons.

In the following description, the X- and Y-directions are in-plane directions of conductive member 31, and the Z-direction is the thickness direction of conductive member 31. The X-, Y-, and Z-directions are perpendicular to one another. Conductive member 31 has metal dispersed in a conductive nitride layer in the in-plane direction (X-Y plane) and in the thickness direction Z. In other words, conductive member 31 includes a plurality of conductive nitride layers 32 and at least one (in this embodiment, a plurality of) nitride-metal layers 33. Conductive member 31 of this embodiment is composed of a plurality of conductive nitride layers 32 and a plurality of nitride-metal layers 33 but may include other conductive layers. The conductive nitride layers 32 and at least one (in this embodiment, a plurality of) nitride-metal layers 33 are alternately stacked, and conductive nitride layers 32 are provided at both ends in the stacking direction (hereinafter sometimes referred to as stacking direction Z because it coincides with the direction of thickness Z). Although FIG. 4A shows five conductive nitride layers 32 and four nitride-metal layers 33, the numbers of conductive nitride layers 32 and nitride-metal layers 33 are not limited. The layer thicknesses (Z-direction dimensions) of the conductive nitride layers 32 can be made the same, and the layer thicknesses (Z-direction dimensions) of the nitride-metal layers 33 can also be made the same. This provision simplifies the manufacturing process.

Conductive nitride layer 32 may be composed of, for example, a nitride selected from the group consisting of titanium nitride, tantalum nitride, chromium nitride, and zirconium nitride. Conductive nitride layer 32 can also be composed of, for example, a nitride obtained by replacing a part of Al in aluminum nitride with at least one element selected from the group consisting of Ti, Ta, Cr, and Zr. Although aluminum nitride is an insulator, it can be made conductive by mixing at least one of the above elements as a dopant into aluminum nitride. Conductive nitride layer 32 can also be composed of, for example, a nitride obtained by replacing a part of Si in silicon nitride with at least one element selected from the group consisting of Ga, C, and B. Although silicon nitride is an insulator, it can be made conductive by mixing at least one of the above elements as a dopant into silicon nitride. A conductive nitride or a nitride made conductive by a dopant functions as a conductive part of conductive member 31 and is therefore preferable in terms of suppressing an increase in the specific resistance of conductive member 31.

Nitride-metal layer 33 includes conductive nitride and metal. Specifically, nitride-metal layer 33 includes metal dispersion layer 33A in which metal is dispersed in a conductive nitride. In this embodiment, nitride-metal layer 33 includes only metal dispersion layer 33A (consists only of metal dispersion layer 33A). In the following description, the conductive nitride part of nitride-metal layer 33 will be referred to as nitride portion 34, and the metal part dispersed in nitride portion 34 will be referred to as metal portion 35. Nitride portion 34 may be composed of any of the above-mentioned conductive nitrides that constitute conductive nitride layer 32, but from the viewpoint of simplifying the manufacturing process, nitride portion 34 is more preferably composed of the same conductive nitride as conductive nitride layer 32. Metal portion 35 may have a multilayer structure of different metals.

The metal may be composed of a single element, but may be composed of an alloy. An example of an alloy may be an alloy consisting of at least two elements selected from the group consisting of Cu, Al, Ti, W, Cr, Mn, Fe, Co, Ni, Zr, Nb, Hf, Ta, Pd, Rh, Ir, In, Mg, Mo, Ga, Ru, Ag, Pt, and Au.

As shown in FIG. 4C, when viewed in the thickness direction Z of metal dispersion layer 33A, a plurality of metal portions 35 are distributed in metal dispersion layer 33A in mutually separated island shapes, and conductive nitrides (nitride portions 34) are continuously distributed, in an arbitrary cross-section perpendicular to the thickness direction Z of metal dispersion layer 33A. In other words, when viewed in the thickness direction Z of metal dispersion layer 33A, in any cross-section perpendicular to the thickness direction Z of metal dispersion layer 33A, the conductive nitride (nitride portion 34) is not divided into a plurality of areas by metal portions 35. Further, in this embodiment, since metal dispersion layer 33A coincides with nitride-metal layer 33, at least a part of the conductive nitride (nitride portion 34) of each nitride-metal layer 33 is continuous from one surface (boundary with one adjacent conductive nitride layer 32) of each nitride-metal layer 33 to the other surface (boundary with the other adjacent conductive nitride layer) in the thickness direction Z of each nitride-metal layer 33. For convenience, FIG. 4A shows that metal parts 35 of the same length are arranged at equal intervals in metal dispersion layer 33A, but the dimensions, planar shape, and spacing of metal portions 35 may be different, and the number of metal portions 35 in each metal dispersion layer 33A may also be different.

Conductive nitride also functions as a barrier layer for the metal portions 35. When metal reacts with water or oxygen to become a metal oxide (insulator), the specific resistance of conductive member 31 increases, and this increase may reduce the performance of infrared sensor 1 and shorten its product lifetime. In this embodiment, conductive nitride layer 32 is provided at both ends of conductive member 31 in the stacking direction Z, and nitride portions 34 are also located to surround metal portions 35 in the in-plane direction of nitride-metal layer 33. Therefore, oxidation of metal portions 35 is less likely to occur.

In conductive member 31 configured in this way, the conductive nitride layers 32 and the nitride-metal layers 33 are alternately stacked, and many heterophase boundary portions 36 are thus formed between conductive nitride layer 32 and metal portion 35. Boundary portions 36 facilitate phonon scattering and contribute to reducing the mean free path of phonons and therefore enable a reduction of the thermal conductivity of conductive member 31. On the other hand, due to the island shape distribution of metal portions 35, many heterophase boundary portions 37 are formed between the conductive nitride (nitride portions 34) and metal portions 35 also in the in-plane direction (X-Y plane) of each nitride-metal layer 33. Boundary portions 37 also facilitate phonon scattering and contribute to reducing the mean free path of phonons and therefore enable a reduction of the thermal conductivity of conductive member 31. In other words, conductive member 31 can facilitate phonon scattering for both phonons propagating in the thickness direction Z and phonons propagating in the in-plane direction (X-Y plane). In particular, metal portions 35 of nitride-metal layer 33 may be made from an alloy. The thermal conductivity of metal portions 35 is lower than that of metal portions 35 composed of a single element, and the thermal conductivity of conductive member 31 can thus be further reduced.

The layer thickness H1 (Z-direction dimension) of nitride-metal layer 33 may be 1 nm or more and less than 10 nm. In this embodiment, the layer thickness H1 of nitride-metal layer 33 is equal to the layer thickness of metal dispersion layer 33A. In particular, a layer thickness of H1 of nitride-metal layer 33 of about 1 nm facilitates achieving a configuration in which nitride-metal layer 33 includes only metal dispersion layer 33A. A layer thickness H2 (Z-direction dimension) of conductive nitride layer 32 may be greater than the layer thickness H1 of nitride-metal layer 33. The layer thickness H2 of conductive nitride layer 32 may be 3 nm or more and 100 nm or less, and particularly about 10 nm. In conductive member 31 of these dimensions, the mean free path of electrons is greater than that of phonons, the mean free path of phonons being, for example, about 10 nm and the mean free path of electrons being 40 to 50 nm. In conductive member 31 of these dimensions, electrons are less likely to be scattered than phonons, thereby facilitating a decrease in thermal conductivity while suppressing a decrease in conductivity.

### Method for Manufacturing Conductive Member 31

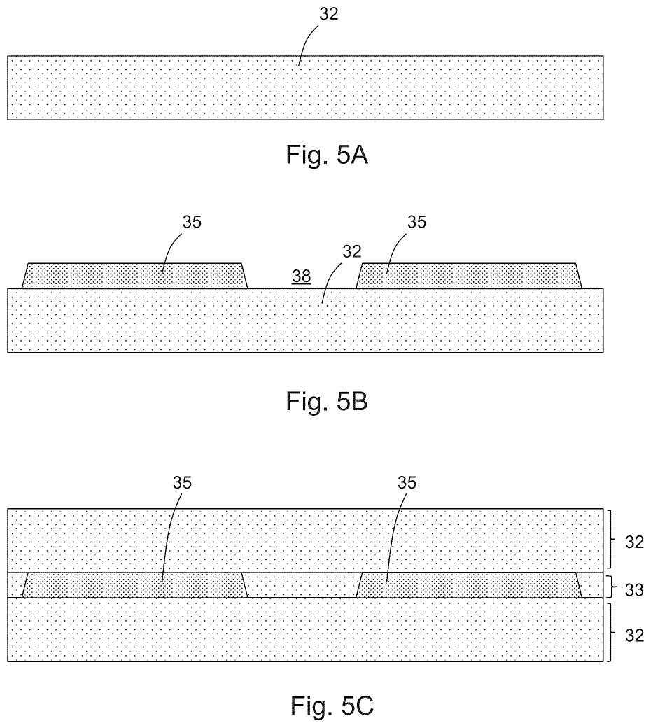

FIGS. 5A to 5C are schematic cross-sectional views showing a method for manufacturing conductive member 31. These figures show the steps of manufacturing a pair of conductive nitride layer 32 and nitride-metal layer 33. Conductive member 31 can be formed by repeating the steps shown in FIG. 5A, followed by the steps shown in FIGS. 5B and 5C. Each step shown in FIGS. 5A to 5C can be performed by a physical vapor deposition method such as a resistance heating evaporation method, an electron beam evaporation method, a molecular beam epitaxy method, an ion plating method, an ion beam deposition method, or a sputtering method. First, as shown in FIG. 5A, conductive nitride layer 32 is formed on a surface (not shown) on which conductive member 31 is to be formed. For example, when upper electrode layer 14 made from conductive member 31 is formed on thermistor film 12, conductive nitride layer 32 is formed on the upper surface of thermistor film 12. Next, as shown in FIG. 5B, metal portions 35 are formed. By adjusting the film-forming conditions as described later, a plurality of metal portions 35 isolated from each other in the X-Y plane as shown in FIG. 4C can be formed on conductive nitride layer 32 in contact with conductive nitride layer 32. Space 38 is formed between meta portions 35. Next, a conductive nitride film is formed as shown in FIG. 5C. A part of the conductive nitride fills space 38 between metal portions 35, and nitride-metal layer 33 is formed by continuing the film formation to form the next conductive nitride layer 32 on nitride-metal layer 33. After this step is completed, the upper surface of conductive nitride layer 32 may be planarized if necessary.

### Second Embodiment

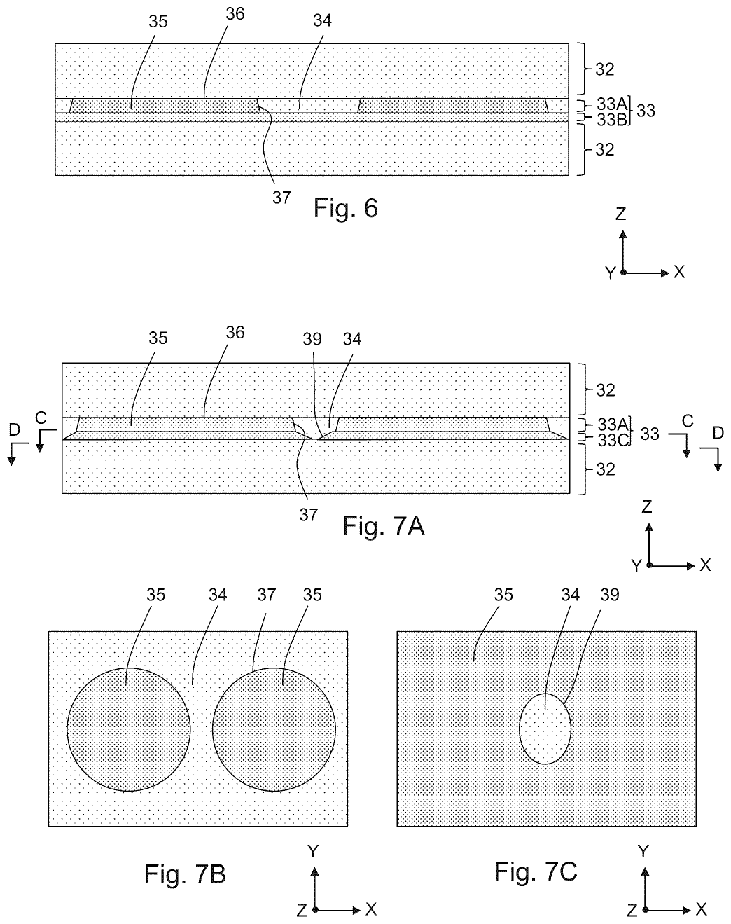

FIG. 6 is a sectional view similar to FIG. 4B and shows the configuration of conductive member 31 in the second embodiment. Nitride-metal layer 33 includes metal dispersion layer 33A and metal layer 33B. The configuration of metal dispersion layer 33A is as described above. Metal layer 33B is composed only of metal and does not include conductive nitride. Metal layer 33B is formed before metal dispersion layer 33A. Also in this embodiment, conductive member 31 can facilitate phonon scattering for both phonons propagating in the thickness direction Z and phonons propagating in the in-plane direction (X-Y plane).

### Third Embodiment

FIG. 7A is a cross-sectional view similar to FIG. 4B showing the configuration of conductive member 31 in the third embodiment, FIG. 7B is a cross-sectional view taken along the line C-C in FIG. 7A, and FIG. 7C is a cross-sectional view taken along the line D-D in FIG. 7A. Nitride-metal layer 33 includes metal dispersion layer 33A and nitride dispersion layer 33C. The configuration of metal dispersion layer 33A is as described above. Nitride dispersion layer 33C is a layer in which conductive nitride is dispersed in metal, and the relationship between the conductive nitride and the metal is opposite to that of metal dispersion layer 33A. Nitride dispersion layer 33C is located between metal dispersion layer 33A and conductive nitride layer 32. Nitride dispersion layer 33C is formed before the metal dispersion layer 33A. In this embodiment, at least a part of the conductive nitride (nitride portion 34) of each nitride-metal layer 33 is continuous from one surface (boundary with one adjacent conductive nitride layer 32) of each nitride-metal layer 33 to the other surface (boundary with the other adjacent conductive nitride layer) in the thickness direction Z of each nitride-metal layer 33. Also in this embodiment, conductive member 31 can facilitate phonon scattering for both phonons propagating in the thickness direction Z and phonons propagating in the in-plane direction (X-Y plane). Further, many boundary portions 39 are also formed between the conductive nitride (nitride portion 34) and metal portion 35 in nitride dispersion layer 33C. Boundary portions 39 also facilitate phonon scattering for both phonons propagating in the thickness direction Z and phonons propagating in the in-plane direction (X-Y plane).

Conductive member 31 of the first to third embodiments can be manufactured by adjusting the film-forming conditions. When using a physical vapor deposition method such as a sputtering method, forming a thin film of approximately several nm at a high rate tends to cause metal portions 35 to grow in island shapes, and conductive member 31 of the first embodiment is likely to be formed. Furthermore, when the free energy of the surface of conductive nitride layer 32 on which the metal film is formed is small or when the surface temperature of conductive nitride layer 32 on which the metal film is formed is low, metal portions 35 tend to grow in island shapes. Forming a thin film of about 10 nm or more by increasing the film-forming time under the same conditions causes the lower sides of metal portions 35 of island shape to connect to each other, resulting in the likelihood that conductive member 31 of the second or third embodiment will be formed. Lengthening the time for forming a metal film on conductive nitride layer 32 (the opening time of shutter 48 in working examples described later) facilitates obtaining a configuration in which metal dispersion layer 33A is formed on nitride dispersion layer 33C as in the third embodiment. Further increasing the time for forming the film increases the likelihood of obtaining a structure in which metal dispersion layer 33A is formed on metal layer 33B as in the second embodiment.

### Working Examples

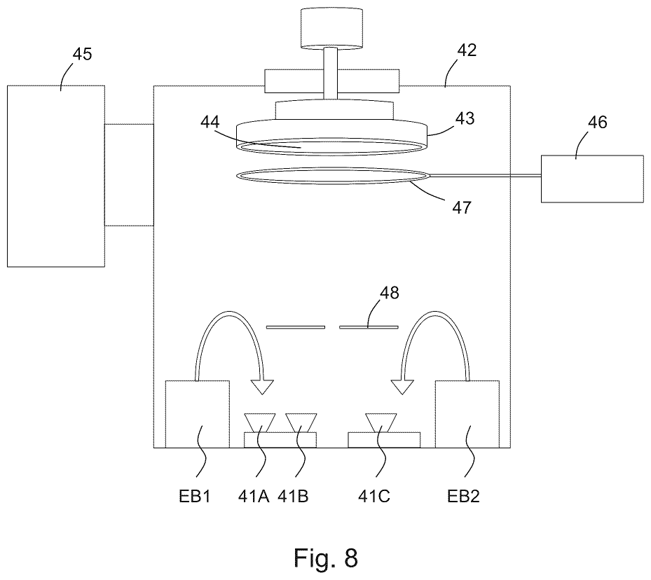

A method for manufacturing conductive member 31 will next be explained in more detail with reference to working examples. Conductive member 31 was manufactured using an electron beam evaporation method. FIG. 8 shows a schematic diagram of the film-forming apparatus used in the working examples. First, Zr, which was used as a part of the conductive nitride, was set in evaporation hearth 41A; Au, which was used as a part of nitride-metal layer 33, was set in evaporation hearth 41B; and Cu, which was used as a part of nitride-metal layer 33, was set in evaporation hearth 41C. Substrate 44 was set on wafer holder 43 in vacuum chamber 42, and vacuum pump 45 was used to reduce the pressure in vacuum chamber 42 to 8×10⁻⁵ (Pa) or less.

Next, a zirconium nitride film was formed. The temperature of substrate 44 was set to 90° C., and nitrogen gas was introduced into vacuum chamber 42 from gas supply device 46 through gas nozzle 47 at a flow rate of 10 sccm. An electron beam was applied at a predetermined power from electron beam source EB1 to heat Zr set in deposition hearth 41A, and a zirconium nitride film was deposited on substrate 44 at a deposition rate of 0.04 nm/sec. Shutter 48 was closed before the evaporation rate reached 0.04 nm/sec, shutter 48 was opened when the evaporation rate reached 0.04 nm/sec, and then shutter 48 was opened for 125 seconds to form zirconium nitride film to a thickness of 5 nm. The opening time of shutter 48 was equal to the forming time of the zirconium nitride film. Immediately after reaching the desired film thickness, shutter 48 was closed, heating by electron beam source EB1 was stopped, and introduction of nitrogen gas was stopped.

Next, an AuCu alloy film was formed. The temperature of substrate 44 was set at 25° C., and an electron beam was applied at a predetermined power from electron beam source EB1 to heat the Au set in deposition hearth 41B. At the same time, an electron beam was applied at a predetermined power from electron beam source EB2 to heat the Cu set in evaporation hearth 41C, Au was deposited at an evaporation rate of 0.3 nm/sec, and Cu was deposited on a zirconium nitride film at an evaporation rate of 0.1 nm/sec. Shutter 48 was closed before the evaporation rate reached these values, and when the evaporation rate reached these values, shutter 48 was opened and remained open for 5 seconds to form an AuCu alloy film to a thickness of 2 nm. The opening time of shutter 48 was equal to the evaporation time of the AuCu alloy film. Immediately after reaching the desired film thickness, shutter 48 was closed and heating by electron beam sources EB1 and EB2 was stopped. Thereafter, the process of forming the zirconium nitride film and the AuCu alloy film was repeated 15 times, following which a zirconium nitride film was formed once. In this manner, conductive member 31 in which metal portions 35 were formed in island shapes as shown in FIGS. 4 and 5 can be formed.

In the process of forming the zirconium nitride film, the temperature of substrate 44 can be selected, for example, from 80 to 100° C., the flow rate of nitrogen gas can be selected, for example, from 1 to 50 sccm, and the evaporation rate of the zirconium nitride film can be selected, for example, from 0.03 to 0.05 nm/sec. In the process of forming the AuCu alloy film, the evaporation rate of Au can be selected, for example, from a range of 0.1 to 0.5 nm/sec, and the evaporation rate of Cu can be selected, for example, from a range of 0.03 to 0.5 nm/sec.

Although certain embodiments of the present disclosure have been shown and described in detail, it should be understood that various changes and modifications may be made without departing from the spirit or scope of the appended claims.

### LIST OF REFERENCE NUMERALS

1 infrared sensor
5 thermistor element
10A, 10B first and second wiring layers
12 thermistor film
13A, 13B first and second lower electrode layers
14 upper electrode layer
31 conductive member
32 conductive nitride layer
33 nitride-metal layer
33A metal dispersion layer
33B metal layer
33C nitride dispersion layer

1. A conductive member, comprising:
a plurality of conductive nitride layers; and
at least one nitride-metal layer that includes a conductive nitride and a metal, wherein:
the conductive nitride layers and the at least one nitride-metal layer are alternately stacked; and
the nitride-metal layer includes a metal dispersion layer in which the metal is dispersed in the conductive nitride.

2. The conductive member according to claim 1, wherein at least a part of the conductive nitride of the at least one nitride-metal layer is continuous from one surface of each nitride-metal layer to an other surface in a thickness direction of each nitride-metal layer.

3. The conductive member according to claim 2, wherein the at least one nitride-metal layer includes only the metal dispersion layer.

4. The conductive member according to claim 2, wherein:
the at least one nitride-metal layer includes a nitride dispersion layer in which the conductive nitride is dispersed in the metal; and
the nitride dispersion layer is located between the metal dispersion layer and one of the conductive nitride layers.

5. The conductive member according to claim 1, wherein the metal is composed of an alloy.

6. The conductive member according to claim 5, wherein the alloy is composed of at least two elements selected from a group consisting of Cu, Al, Ti, W, Cr, Mn, Fe, Co, Ni, Zr, Nb, Hf, Ta, Pd, Rh, Ir, In, Mg, Mo, Ga, Ru, Ag, Pt and Au.

7. The conductive member according to claim 1, wherein a layer thickness of each of the conductive nitride layers is greater than a layer thickness of the nitride-metal layer.

8. The conductive member according to claim 7, wherein the layer thickness of each of the conductive nitride layers is 3 nm or more and 100 nm or less.

9. The conductive member according to claim 7, wherein the layer thickness of the nitride-metal layer is 1 nm or more and less than 10 nm.

10. The conductive member according to claim 1, wherein:
the at least one nitride-metal layer includes a plurality of nitride-metal layers;
layer thicknesses of the conductive nitride layers are the same; and
layer thicknesses of the nitride-metal layers are the same.

11. The conductive member according to claim 1, wherein
the conductive nitride layers are composed of a nitride selected from a group consisting of titanium nitride, tantalum nitride, chromium nitride, and zirconium nitride, or
composed of a nitride obtained by replacing a part of Al in aluminum nitride with at least one element selected from a group consisting of Ti, Ta, Cr, and Z, or
composed of a nitride obtained by replacing a part of Si in silicon nitride with at least one element selected from a group consisting of Ga, C, and B.

12. A conductive member, comprising:
a conductive nitride layer; and
a metal dispersed in the conductive nitride layer.

13. A thermistor element, comprising:
a thermistor film;
an electrode layer in contact with one surface of the thermistor film; and
a wiring layer in contact with the electrode layer, wherein
at least one of the electrode layer and the wiring layer is formed of the conductive member according to claim 1.

14. A thermistor element, comprising:
a thermistor film;
an electrode layer in contact with one surface of the thermistor film; and
a wiring layer in contact with the electrode layer, wherein
at least one of the electrode layer and the wiring layer is formed of the conductive member according to claim 12.
